(19) United States
(12) Patent Application Publication
(10) Pub. No.: US 2008/0076486 A1
(43) Pub. Date: Mar. 27, 2008

(54) REINFORCED CASING DEVICE FOR MOBILE HANDSET

(76) Inventor: Shih-Yang CHAN, Taipei Hsien (TW)

Correspondence Address: LEONG C LEI, PMB # 1008, 1867 YGNACIO VALLEY ROAD, WALNUT CREEK, CA, 94598, US

(21) Appl. No.: 11/420,487

(22) Filed: May 26, 2006

(51) Int. Cl. H04M 1/00

(52) U.S. Cl. 455/575.1

(57) ABSTRACT

A casing device for mobile handsets is provided. The casing device contains an outer member integrally molded using a ceramics material, and a reinforcement member adhered to the inner surface of the outer member so as to enhance the robustness of the outer member against external impacts. The reinforcement member can be made a plastic material injection molded on the inner surface of the outer member or a metallic material attached to the inner surface of me outer member by an adhesive.

### BACKGROUND OF THE INVENTION

(a) Technical Field of the Invention

The present invention generally relates to casing devices, and more particularly to a mobile handset casing device having a ceramic outer member whose inner surface is attached with a reinforcement member.

(b) Description of the Prior Art

Mobile handsets or cellular phones have become indispensable accessories in people's daily life as the advancement of wireless communications has offered unparalleled convenience and mobility. The mobile handsets therefore have evolved from simple communications devices to fashionable items as demands continuously drive the industry for handsets with more appealing styles and appearances.

Conventionally, most mobile handsets have plastic or metallic cases molded into various shapes and colored by spray painting or japanning. The plastic cases, with Inferior hardness, suffer scratches and smudges after a period of usage. On fee other hand, the japanning coaling on the metallic cases would peel off after a period of usage or under external impact.

In these respects, ceramics is a more appropriate material than plastics or metal. However, casing devices for mobile handsets are usually very thin and ceramic-made casing devices would easily shatter when under external impacts. This has significantly reduced the applicability of ceramics in making casing devices for mobile handsets.

### SUMMARY OF THE INVENTION

The primary purpose of tie present invention is to Accordingly, a casing device for mobile handsets is provided. The casing device contains an outer member integrally molded using a ceramics material, and a reinforcement member tightly adhered to me inner surface of the outer member so as to enhance the robustness of the outer member against external impacts.

The reinforcement member can be made from a metallic plate and closely attached to the inner surface of the ceramic outer member by an adhesive. The reinforcement member has fastening elements so as to be joined to the body of a mobile handset.

The reinforcement member can also be made of a plastic material and is formed by injection molding directly on the inner surface of the ceramic outer member. The reinforcement member has fastening elements so as to be joined to the body of a mobile handset.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with, the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a casing device according to an embodiment of the present invention, and a mobile handset to which the casing device is affixed.

FIG. 2 is a perspective diagram showing the assembly of the casing device and the mobile handset of FIG. 1.

FIG. 3 is a cross-sectional diagram of the casing device along the 3-3 line of FIG. 2.

FIG. 4 is a cross-sectional diagram showing a casing device according to another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

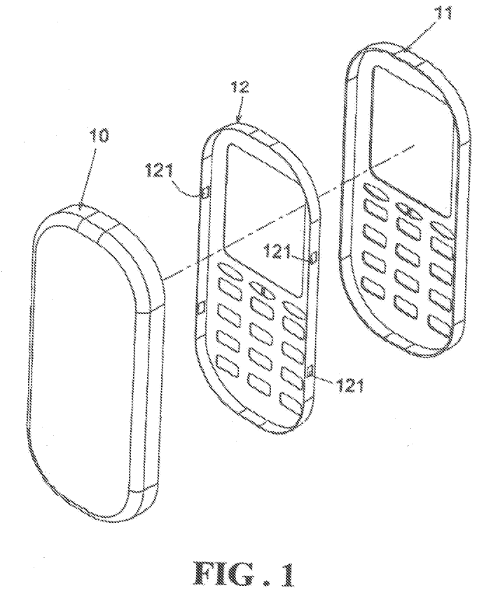

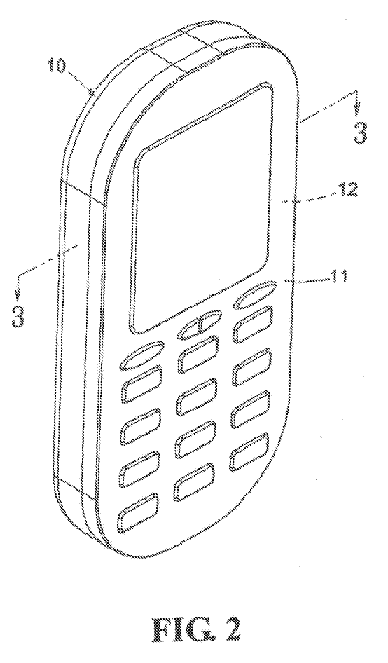

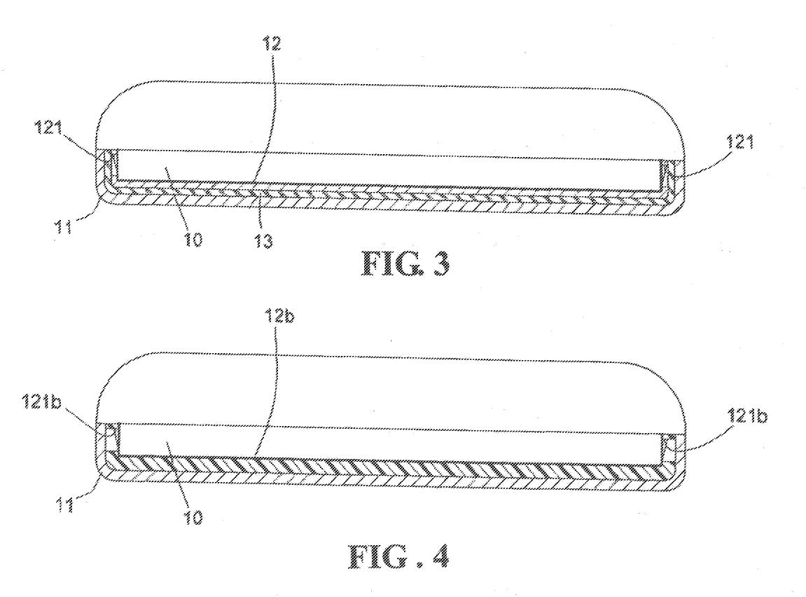

As shown in FIGS. 1 to 3, a casing device for mobile handsets is provided, which contains an outer member 11 and a reinforcement member 12. The reinforcement member 12 is tightly attached to the inner surface of the outer member 11 so that the outer member 11 can have better structural strength to effectively prevent being shattered by external impacts.

The casing device as described can function as fee entire enclosure to a mobile handset 10 (i.e., enclosing fee mobile handset 10 entirely), or it can be a part of fee enclosure to fee mobile handset 10 (i.e., enclosing a part of fee body of fee mobile handset 10 such as its front surface).

The outer member 11 is made of a ceramics material such as zirconia integrally molded into a single piece. Please note that, in alternative embodiments, other appropriate ceramics materials can also be used.

The reinforcement member 12 is made of a metallic material and can be formed by stamping a metallic plate. The metallic reinforcement member 12 is tightly attached to the inner surface of the outer member 11 by an adhesive 13. The reinforcement member 12 has fastening elements 121 along its inner surface (i.e., the surface facing the mobile handset 10) so as to be joined to the corresponding fastening elements on the body of the mobile handset 10. As such the casing device can be reliably attached to the mobile handset 10. The locations and styles of the fastening elements 121 are not limited to those shown in the diagrams. For example, the fastening elements 121 can be elastic hooks for locking into corresponding notches on the mobile handset 10, or the fastening elements 121 can be notches for receiving hooks on the mobile handset 10.

As shown in FIG. 4, the reinforcement member 12b of another embodiment is made of a plastic material and can be formed directly on inner surface of an outer member 11 by injection molding to the outer member 11 placed inside a mold. Similarly the reinforcement member 12b has fastening elements 121b along its inner surface (i.e., the surface facing the mobile handset 10) so as to be joined to the corresponding fastening elements on the body of the mobile handset 10. As such the casing device can be reliably attached to the mobile handset 10. The locations and styles of the fastening elements 121b are not limited to those shown in the diagrams. For example, the fastening elements 121b can be elastic hooks for locking into corresponding notches on the mobile handset 10, or the fastening elements 121b can be notches for receiving hooks on the mobile handset 10.

The casing device as described has a number of advantages over prior arts. First, fine ceramics material allows the casing device to have various colors feat won't fade away after a period of usage. Secondly, the fine ceramics material offers superior hardness and smoothness to withstand scratches, abrasion, and smears. The casing device therefore can still look like new even after extended period of usage. Additionally, the closely attached reinforcement member 12 or 12b effectively enhance the structural strength of the outer member 11 so that it will not shatter easily under external impacts.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A casing device for a mobile handset, comprising an outer member made of a ceramics material and a reinforcement member tightly attached to the inner surface of said outer member.

2. The casing device according to claim 1, wherein said casing device completely encloses the body of said mobile handset.

3. The casing device according to claim 1, wherein said casing device encloses a part of the body of said mobile handset.

4. The easing device according to claim 1, wherein said reinforcement member is made of a plastic material and said reinforcement member is attached to the inner surface of said outer member by an adhesive.

5. The casing device according to claim 1, wherein said reinforcement member is made of a metallic material and said reinforcement member is injection-molded directly on the inner surface of said outer member.

6. The casing device according to claim 1, wherein said reinforcement member has a plurality of fastening elements for joining said casing device to said mobile handset.

7. The casing device according to claim 6, wherein said fastening elements are elastic hooks.

8. The easing device according to claim 6, wherein said fastening elements are notches.
